(19) United States
(12) Patent Application Publication
(10) Pub. No.: US 2018/0210138 A1
(43) Pub. Date: Jul. 26, 2018

(54) Lighting System With Lightguide Formed From Multiple Optical Materials

(71) Applicant: Cooper Technologies Company, Houston, TX (US)

(72) Inventor: Scott David Wegner, Peachtree City, GA (US)

(21) Appl. No.: 15/879,288

(22) Filed: Jan. 24, 2018

Related U.S. Application Data
(60) Provisional application No. 62/449,842, filed on Jan. 24, 2017.

(51) Int. Cl. F21V 8/00; G02B 1/04

(52) U.S. Cl. CPC G02B 6/0065; G02B 1/045; G02B 6/008; G02B 6/0093; G02B 6/0068; G02B 6/0078

(57) ABSTRACT

A lighting system includes a light source and a lightguide. The lightguide has a first edge disposed adjacent the light source to receive light from the light source and a second edge on a side opposite to the first edge, the second edge configured to emit at least a portion of the received light. The lightguide also has a first major surface and a second major surface that extend between the first edge and the second edge and that are on opposite sides of the lightguide. The first major surface and the second major surface internally reflect at least a portion of the received light. The lightguide consists of a first optical material and a second optical material, wherein the first optical material is disposed at the first edge adjacent to the light source and has a higher temperature rating than a second optical material.

### RELATED APPLICATIONS

The present application claims priority under 35 U.S.C. § 119 to U.S. Provisional Patent Application No. 62/449,842, titled “Lighting System With Lightguide Formed From Two Optical Materials,” and filed Jan. 24, 2017, the entire contents of which are hereby incorporated herein by reference.

### TECHNICAL FIELD

Embodiments of the technology relate generally to illumination systems and more particularly to a lighting system that incorporates a lightguide formed from two or more optical materials, one having a higher temperature tolerance than the other.

### BACKGROUND

Lightguides are useful for managing light produced by light emitting diodes (LEDs). An array of light emitting diodes may be positioned adjacent to an edge of a lightguide made of acrylic, so that the light emitting diodes emit light into the lightguide via the edge, and the lightguide processes the light. However, the heat produced by the light emitting diodes can soften or otherwise adversely impact the acrylic, particularly if the light emitting diodes are operated at a high output.

Accordingly, a need exists for lightguides that can manage light produced by light emitting diodes while tolerating heat associated with running the light emitting diodes with a high level of current. A need further exists for economical lightguides that can receive light from hot light emitting diodes. A technology to address such needs would promote broader utilization of light emitting diodes in illumination applications.

### SUMMARY

In one example embodiment, the present disclosure describes a lighting system comprising a light source and a lightguide. The lightguide can comprise a first edge disposed adjacent the light source and a second edge on the opposite side of the lightguide from the first edge, the second edge configured to emit a portion of the light from the light source. A first major surface and a second major surface extend between the first edge and the second edge. The first major surface and the second major surface internally reflect light passing through the lightguide between the first edge and the second edge. The lightguide can comprise a first optical material forming a first section extending from the first edge and towards the second edge. The lightguide can further comprise a second optical material forming a second section extending from the second edge towards the first edge.

In another example embodiment, a lighting system can comprise a light source, a lightguide formed of a thermoplastic optical material and an optic disposed between the light source and the lightguide. The lightguide comprises a light-receiving surface oriented towards the optic and the light source. The lightguide further comprises a light-emitting surface that is on the opposite side of the lightguide from the light-receiving surface. The lightguide further comprises a first major surface and a second major surface that extend between the light-receiving surface and the light-emitting surface. The first major surface and the second major surface internally reflect light passing through the lightguide between the light-receiving surface and the light-emitting surface. The optic is formed of a thermoset material that has a higher melting temperature than the thermoplastic optical material of the lightguide.

In yet another embodiment, a method of making a lightguide is disclosed. The method comprises providing a plate that is formed of an acrylic optical material and that comprises an edge. The method further comprises forming an optic at the edge of the plate by molding silicone to the edge of the plate, wherein the plate and the formed optic comprise the lightguide.

These and other aspects, objects, features, and embodiments will be apparent from the following description and the appended claims.

### BRIEF DESCRIPTION OF THE FIGURES

The drawings illustrate only example embodiments of methods, systems, and devices for lighting systems using lightguides formed from multiple optical materials and are therefore not to be considered limiting in scope, as they may admit to other equally effective embodiments. The elements and features shown in the drawings are not necessarily to scale, emphasis instead being placed upon clearly illustrating the principles of the example embodiments. Additionally, certain dimensions or positions may be exaggerated to help visually convey such principles. In the drawings, reference numerals designate like or corresponding, but not necessarily identical, elements.

FIG. 1A illustrates a cross-sectional side view of a lighting system in accordance with an example embodiment of the present disclosure.

FIG. 1B illustrates a perspective view of the lighting system of FIG. 1A.

FIG. 2 illustrates a cross-sectional side view of another lighting system in accordance with an example embodiment of the present disclosure.

FIG. 3 illustrates a cross-sectional side view of yet another lighting system in accordance with an example embodiment of the present disclosure.

FIG. 4 illustrates a cross-sectional side view of yet another lighting system in accordance with an example embodiment of the present disclosure.

FIG. 5A illustrates a cross-sectional side view of the lightguide of the lighting system of FIG. 1A.

FIG. 5B illustrates a perspective view of the lightguide of the lighting system of FIG. 1A.

FIG. 6A illustrates a cross-sectional side view of another lightguide in accordance with an example embodiment of the present disclosure.

FIG. 6B illustrates a perspective view of the lightguide of FIG. 6A.

FIG. 7A illustrates a cross-sectional side view of yet another lightguide in accordance with an example embodiment of the present disclosure.

FIG. 7B illustrates a perspective view of the lightguide of FIG. 7A.

FIG. 8A illustrates a cross-sectional side view of yet another lightguide in accordance with an example embodiment of the present disclosure.

FIG. 8B illustrates a perspective view of the lightguide of FIG. 8A.

FIG. 9A illustrates a detailed perspective view of yet another lightguide in accordance with an example embodiment of the present disclosure.

FIG. 9B illustrates a cross-sectional side view of the lightguide of FIG. 9A.

FIG. 9C illustrates a full perspective view of the lightguide of FIG. 9A.

FIG. 9D illustrates a top view looking down on the lightguide of FIG. 9A.

### DETAILED DESCRIPTION OF EXAMPLE EMBODIMENTS

A lighting system can comprise a lightguide that receives light from an array of light emitting diodes. As used herein, a lightguide refers to a material that transmits light from one side of the material to the other side of the material using total internal reflection, at least along a portion of the lightguide, to guide the light as it passes through the material. The lightguide can take a variety of shapes, such as a rectangular prism, a partial cylinder or cone, or any of a variety of other irregular shapes. In the example embodiments described herein, a portion of the lightguide that is disposed adjacent the array of light emitting diodes can be formed of a heat-tolerant optical material, such as optical silicone or another appropriate thermoset plastic. Another portion of the lightguide can be formed of another optical material, such as acrylic or another appropriate thermoplastic, that may be less heat tolerant, more economical or have higher rigidity or other appropriate mechanical properties. As used herein, an optical material is a material that is translucent.

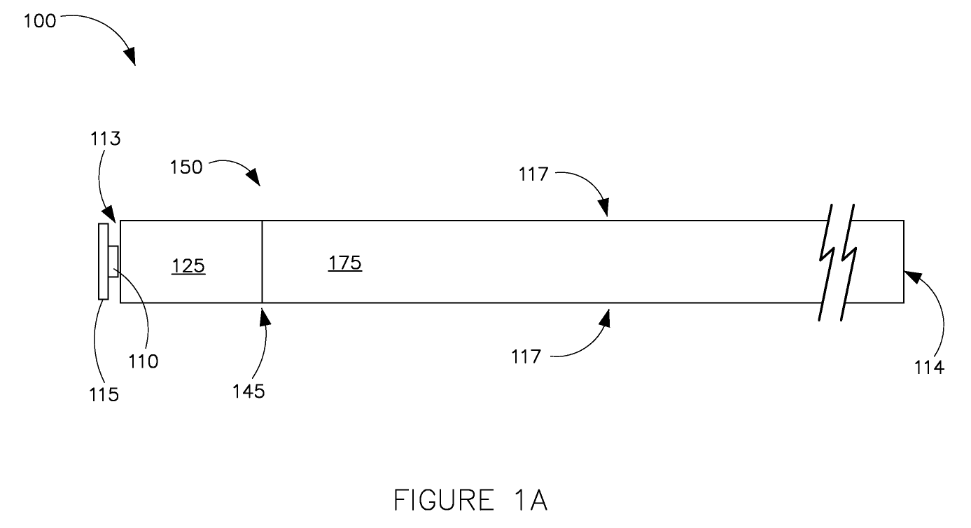

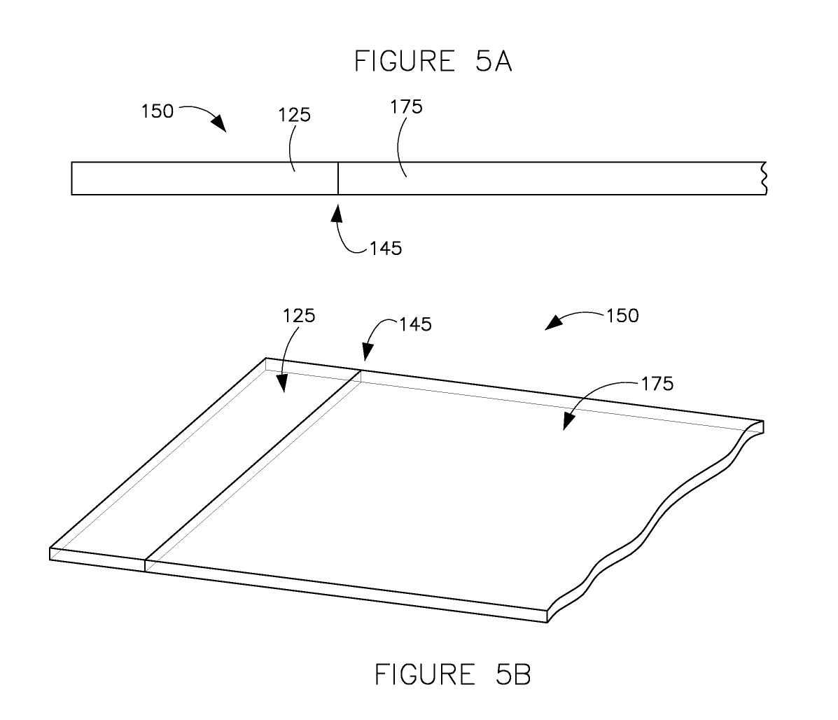

Some representative embodiments will be described more fully hereinafter with example reference to the accompanying drawings that illustrate embodiments of the technology. The technology may, however, be embodied in many different forms and should not be construed as limited to the embodiments set forth herein; rather, these embodiments are provided so that this disclosure will be thorough and complete, and will fully convey the scope of the technology to those appropriately skilled in the art. FIGS. 1, 2, 3, and 4 illustrate four example embodiments of a lighting system incorporating hybrid lightguides. FIGS. 5, 6, 7, 8, and 9 illustrate example embodiments of lightguides that may be incorporated into a lighting system.

The drawings illustrate only example embodiments and are therefore not to be considered limiting of the embodiments described, as other equally effective embodiments are within the scope and spirit of this disclosure. The elements and features shown in the drawings are not necessarily drawn to scale, emphasis instead being placed upon clearly illustrating principles of the embodiments. Additionally, certain dimensions or positions may be exaggerated to help visually convey certain principles. In the drawings, similar reference numerals among different figures designate like or corresponding, but not necessarily identical, elements.

Turning now to the FIGS. 1A and 1B (collectively FIG. 1), a lighting system 100 comprising a lightguide 150 is illustrated in accordance with some example embodiments. FIG. 1A illustrates a side view of the lighting system 100. FIG. 1B illustrates a perspective view of the lightguide 150 that lighting system 100 comprises. The illustrated lighting system 100 can be characterized as comprising a luminaire that provides illumination, for example.

As illustrated, a linear array of light emitting diodes 110 is mounted on a circuit board 115. The light emitting diodes 110 emit light into the lightguide 150 via a light-receiving edge 113. Thus, the lightguide 150 has a light-receiving edge 113 that extends adjacent the light emitting diodes 110, and light couples from the light emitting diodes 110 into the lightguide 150. The lightguide 150 guides the received light towards and for emission from an opposing, light-emitting edge 114 of the lightguide 150, to provide illumination. As illustrated, the lightguide 150 comprises two major surfaces 117 that guide light between the light-receiving and light-emitting lightguide edges 113, 114 via total internal reflection. The major surfaces 117 of the lightguide 150 extend between the light-receiving edge 113 and the light-emitting edge 114 in the illustrated example. Two lateral edges 107 extend between the light-receiving edge 113 and the light-emitting edge 114 and further extend between the two major surfaces 117 of the lightguide 150.

In some example embodiments, one or both of the major surfaces 117 may be patterned with micro-optical features that emit internally incident light and further may provide directional control of the emitted light. The micro-optical features can help release light in a controlled fashion with directional bias, so that the major surfaces 117 totally internally reflect a portion of internally incident light while transmitting another portion of internally incident light as emitted light directed out of one or both of the major surfaces 117. The resulting emitted light can be biased down towards a floor or laterally so that a produced illumination pattern may be beneficially directed for occupant visibility, for example.

In various example embodiments, micro-optical features on at least one of the major surfaces 117 can comprise microlenses, conical features, truncated cones, convex shapes, holes, concave structures, dimples, or other appropriate features, for example. In some example embodiments, the lightguide 150 can comprise one or more of the technologies disclosed in U.S. Pat. No. 8,459,858, the entire contents of which are hereby incorporated herein by reference. In some example embodiments, the lightguide 150 can comprise one or more of the technologies disclosed in U.S. Pat. No. 7,357,553, the entire contents of which are hereby incorporated herein by reference.

As illustrated, the lightguide 150 comprises two lightguide sections 125, 175 that are formed of different materials as discussed below. In addition to being characterized as two lightguide sections 125, 175 of one lightguide 150, the lightguide section 125 can be viewed as one lightguide, and the lightguide section 175 can be viewed as another lightguide. Other embodiments may comprise three, four, five, or more lightguide sections having different compositions, for example.

In an example embodiment, the lightguide section 175 is formed from a thermoplastic optical material, such as optically transparent acrylic or polycarbonate. Thus, the lightguide section 175 can melt or otherwise degrade at a high temperature (its upper temperature rating). Meanwhile, the lightguide section 125, which is closest to the light emitting diodes 110, can comprise a thermoset optical material, for example transparent silicone. The thermoset optical material of the lightguide section 125 can operate without failure at a higher temperature (its upper temperature rating) than the thermoplastic material. In the illustrated example configuration, the lightguide section 125 that can tolerate operation at a higher temperature is located closer to the light emitting diodes 110 than the lightguide section 175. Thus, the lightguide section 125 tolerates heat produced by operation of the light emitting diodes 110 better than the lightguide section 175.

The illustrated hybrid configuration provides a lightguide 150 that is formed of at least two materials. The material of the lightguide section 125 is rated at a high temperature associated with operating the light emitting diodes 110. Another material in the lightguide section 175 is less tolerant of high heat and is rated at a lower temperature but may offer other useful properties. The material in the lightguide section 175 can have higher rigidity, be more economical, or have higher clarity than the material in the lightguide section 125, for example.

As illustrated, the two lightguide sections 125, 175 meet to form an interface 145 that extends between the major surfaces 117 of the lightguide 150. The interface 145 further extends between the two lateral edges 107 of the lightguide 150. The interface 145 is formed where the respective surfaces of the two lightguide sections 125, 175 adjoin and meet one another.

In one example fabrication embodiment, molding the lightguide section 125 onto the lightguide section 175 produces the lightguide 150. That is, the lightguide section 175 can start as a plate of optical material that comprises a lightguide. In some example embodiments, a primer or adhesion promoter is applied to the edge of the plate of optical material prior to attaching the two lightguide sections 125 and 175 to promote material adhesion at the interface 145. The plate of optical material can be placed in a mold that has a cavity corresponding to the lightguide section 125. Silicone or other appropriate optical plastic can be injected into the cavity and cured. When cured, the silicone bonds to the plate of optical material with the bond line forming the interface 145. The finished lightguide 150 can then be extracted from the mold in an integrated state.

In another example embodiment, the lightguide section 125 is formed first of silicone or other appropriate thermoset plastic or thermoplastic that can tolerate high temperature associated with the operating the light emitting diodes 110. A molding process can form the lightguide section 125, for example. Once molded or otherwise formed, the lightguide section 125 can be placed in another mold having a cavity corresponding to the lightguide section 175. The thermoplastic material of the lightguide section 175 can be injected into that cavity. Once the thermoplastic material has hardened, for example by cooling, the finished lightguide 150 can be extracted from the mold in an integrated state.

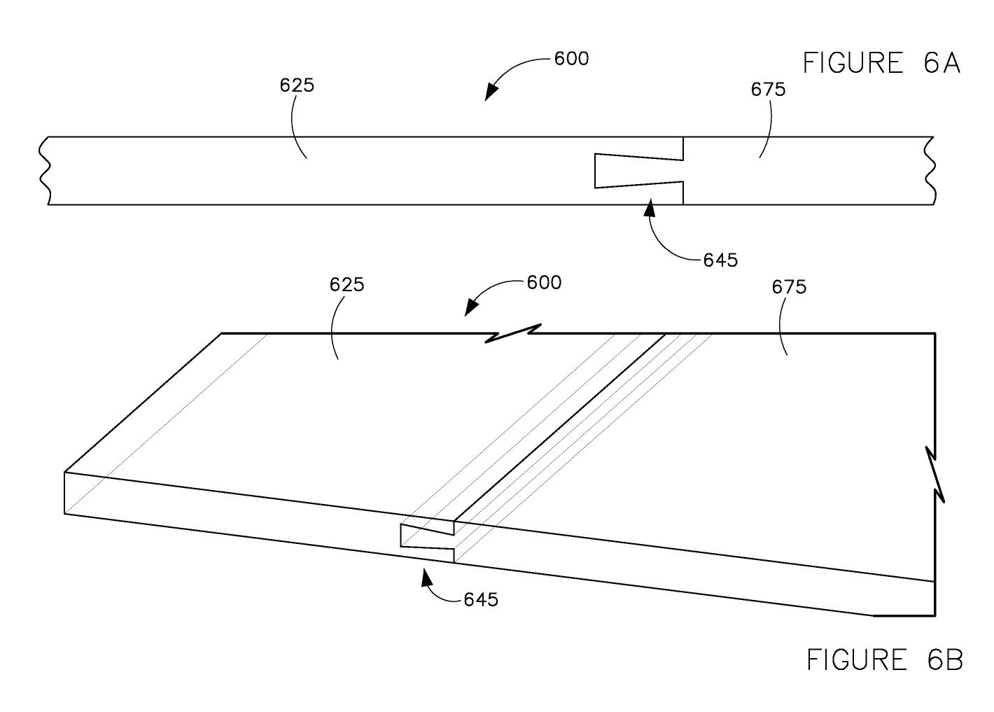

In another example embodiment, the lightguide section 125 and the lightguide section 175 are formed separately and are subsequently attached to one another at the interface 145. They may be attached via adhesive, bonding, fusion, or other appropriate attachments means. As discussed in further detail below with reference to FIGS. 6, 7, 8, and 9, in some embodiments, a dovetail joint, a tongue-in-groove joint, a shelf joint, or other appropriate mechanical joint may be utilized for the interface 145. Such joints may utilize mechanical force or a combination of mechanical force and chemical force for maintaining interface integrity. In some embodiments, the two lightguide materials are very close to each other without chemical bonding, for example with a very slight air gap between them. In some embodiments, as the lightguide materials touch, “wetting” of the two adjoining surfaces occurs so they may behave as if chemically bonded. The durometer of the silicone can be sufficiently soft to be somewhat sticky, thereby promoting long-term contact with the acrylic surface. The result can be elimination of an air gap and wetting that promotes light transfer between the two materials. In some example embodiments, the lightguide sections 125, 175 are mated together mechanically (for example using a dovetail joint, a tongue-in-groove joint, a shelf joint, or other appropriate mechanical joint), and the adjoining surfaces at the joint are further chemically bonded together using an adhesive or other appropriate means. In some example embodiments of such an approach, the mechanical mating supports structural integrity, and the chemical bond eliminates any air gap to facilitate optical transmission.

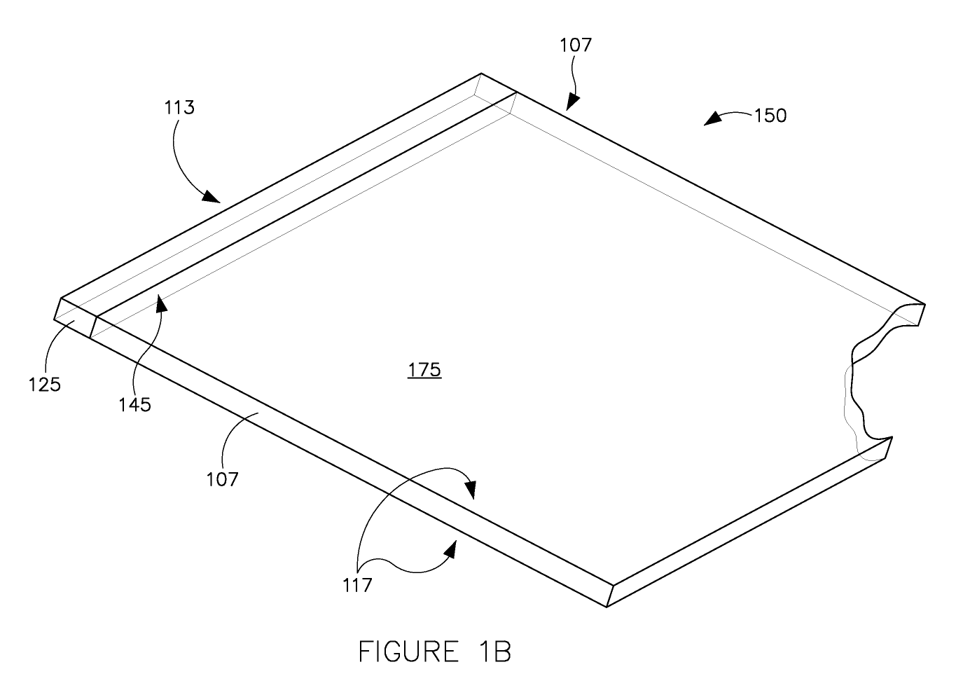

Turning now to FIG. 2, another lighting system 200 that comprises another hybrid lightguide embodiment is illustrated in accordance with some example embodiments. The example lightguide 150B comprises the lightguide section 175, as discussed above, and another lightguide section 225 that are joined at an interface 145. Like the lightguide section 125 discussed above with respect to FIG. 1, the lightguide section 225 comprises an optical material that can better tolerate heat produced by operation of the light emitting diodes 110 than the lightguide section 175.

The lightguide section 225 not only guides light as discussed above, but also provides a mount for a plate of glass 275 (or other transparent or translucent material) that physically protects the lightguide 150B, for example from abrasion. The lightguide section 225 comprises a projection 255 that comprises a channel 260. The plate of glass 275 is mounted to the projection 225 via an edge that is disposed in the channel 260 of the projection 225.

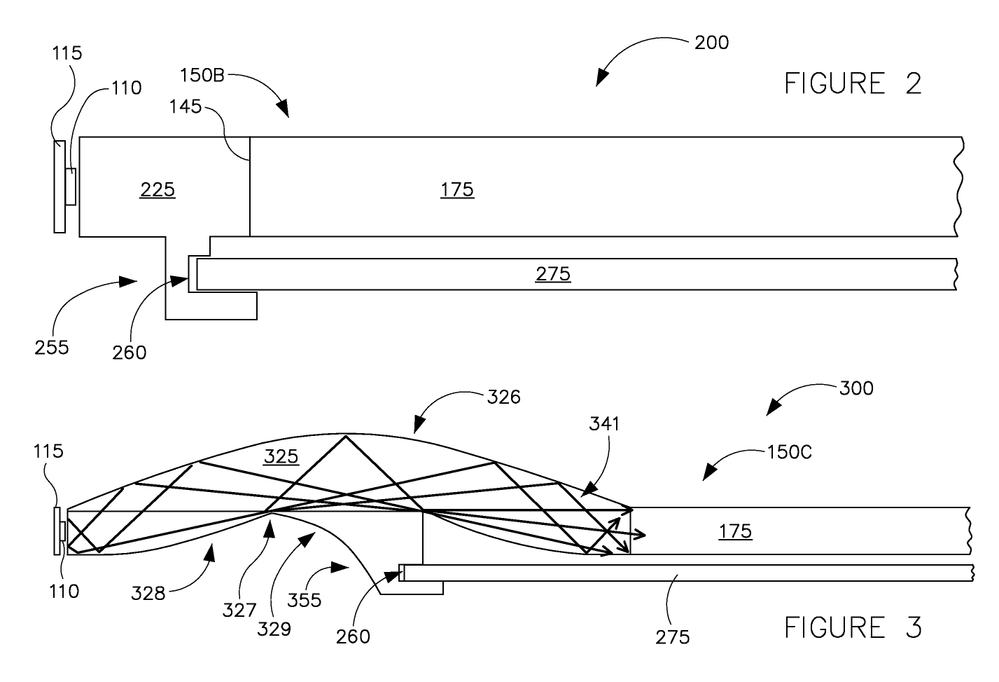

While several example lightguide sections described and shown herein are rectangular cuboids, the lightguide sections can take a variety of other shapes. Turning now to FIG. 3, another lighting system 300 that comprises another hybrid lightguide embodiment is illustrated in accordance with some example embodiments. The example lightguide 150C comprises the lightguide section 175, as discussed above, and another lightguide section 325. Like the lightguide section 125 discussed above with respect to FIG. 1, the lightguide section 325 comprises an optical material with elevated heat tolerance as compared to the lightguide section 175.

The lightguide section 325 guides light from the light emitting diodes 110 to the lightguide section 175 and further provides a mount for a plate of glass 275 that protects the lightguide 150 as discussed above. Similar to the lightguide section 225 illustrated in FIG. 2 and discussed above, the lightguide section 225 comprises a projection 355 that comprises a channel 260 in which the plate of glass 275 is mounted.

In the example embodiment of FIG. 3, the lightguide section 325 is contoured to divert light around the projection 355 to facilitate coupling light into the lightguide section 175. The side of the lightguide section 355 that is oriented towards the plate of glass 275 comprises a concave surface 329 that meets a protruding surface 228 at an inflection point 327. The opposite side of the lightguide section 355 comprises a convex surface 326. These surfaces 326, 328, 329 are totally internally reflective to channel light rays 341 for efficient coupling of light to the lightguide section 175 as illustrated.

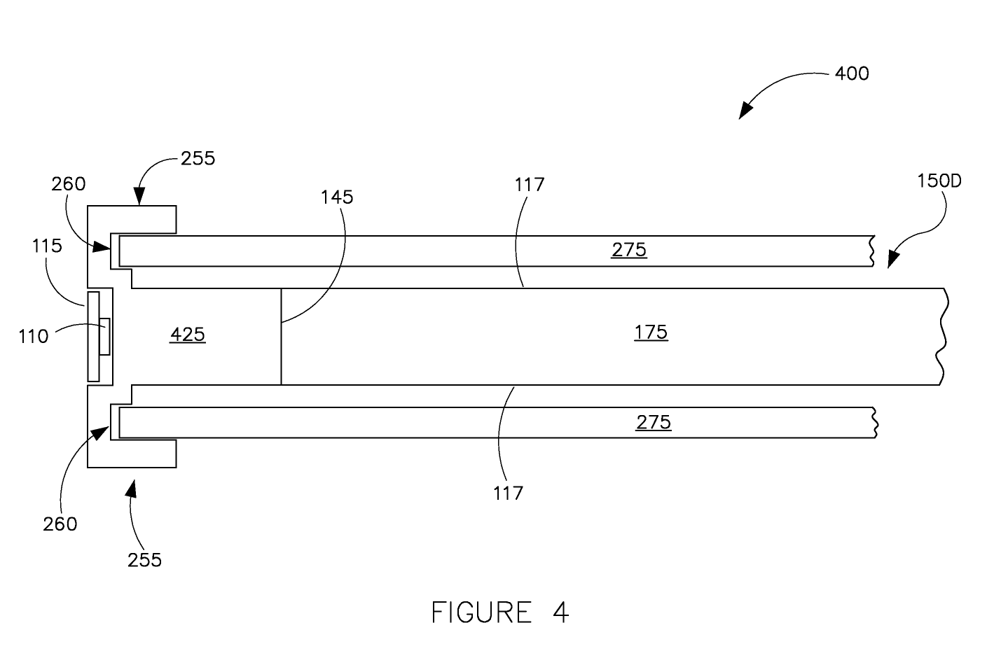

Turning now to FIG. 4, another lighting system 400 that comprises another hybrid lightguide embodiment is illustrated in accordance with some example embodiments. The example lightguide 150D comprises the lightguide section 175, as discussed above, and another lightguide section 425 that meet at interface 145. Like the lightguide sections 125, 225, and 325 discussed above with respect to FIGS. 1, 2, and 3 the lightguide section 425 comprises an optical material that can withstand heat produced by operation of the light emitting diodes 110 better than the lightguide section 175.

Similar to the lighting system 200 illustrated in FIG. 2, the lightguide section 425 of the lighting system 400 provides a mount. However, in the lighting system 400 of FIG. 4, the lightguide section 425 comprises two projections 255, each with a respective channel 260 in which a respective plate of glass 275 is mounted. Thus, the lighting system 200 comprises two plates of glass 275 that are mounted to the lightguide section 225. The two plates of glass 275 can protect both major faces 117 of the lightguide section 175 from abrasion and from environmental contamination, such as debris in an outdoor application.

Turning now to FIGS. 5, 6, 7, 8, and 9, representative lightguide embodiments will be discussed in further detail. The various representative lightguide embodiments illustrated in FIGS. 5-9 can be implemented in any of the example lighting systems described in connection with FIGS. 1-4.

FIGS. 5A and 5B (collectively FIG. 5) illustrate the lightguide 150 from FIG. 1 in further detail. The lightguide 150 comprises two lightguide sections 125, 175 that are formed of different materials as discussed above.

FIGS. 6A and 6B (collectively FIG. 6) illustrate another representative lightguide 600 in accordance with some example embodiments. FIG. 6A illustrates a cross sectional view, while FIG. 6B illustrates a perspective view. The lightguide 600 comprises two lightguide sections 625, 675 that are both formed of optical materials. The lightguide section 625 is formed of an optical material that is rated at a higher operating temperature than the optical material of the lightguide section 675. As discussed above, the lightguide section 625 may be formed of a heat-tolerant material such as optical grade silicone, while the lightguide 675 may be formed of acrylic or another appropriate optical material. The two lightguide sections 625, 675 adjoin one another at an interface 645 through which light passes during operation. In the embodiment of FIG. 6, the interface 645 comprises a dovetail joint. In an example embodiment, the lightguide section 625 can be formed of a silicone material that has a soft durometer to facilitate material deformation during assembly of the interface 645 and long-term surface contact with lightguide section 675 via a wetting effect.

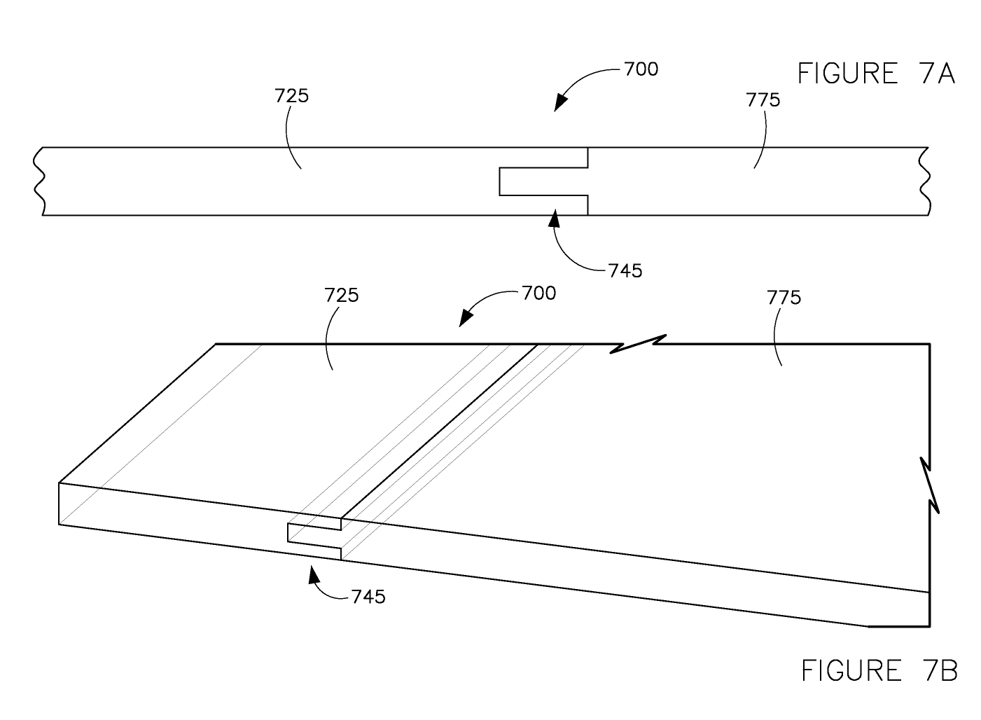

FIGS. 7A and 7B (collectively FIG. 7) illustrate another representative lightguide 700 in accordance with some example embodiments. FIG. 7A illustrates a cross sectional view, while FIG. 7B illustrates a perspective view. The lightguide 700 comprises two lightguide sections 725, 775 that are both formed of optical materials. The lightguide section 725 is formed of an optical material that is rated at a higher operating temperature than the optical material of the lightguide section 775. As discussed above, the lightguide section 725 may be formed of a heat-tolerant material such as optical grade silicone, while the lightguide 775 may be formed of acrylic or another appropriate optical material. The two lightguide sections 725, 775 adjoin one another at an interface 745 through which light passes during operation. In the embodiment of FIG. 7, the interface 745 comprises a tongue-in-groove joint 745. In the illustrated example of FIG. 7, the lightguide section 725 comprises the groove, and the lightguide section 775 comprises the tongue. In an example embodiment, the lightguide section 725 can be formed of a silicone material that has a soft durometer to facilitate material deformation during assembly of the interface 745 and long-term surface contact with lightguide section 775 via a wetting effect.

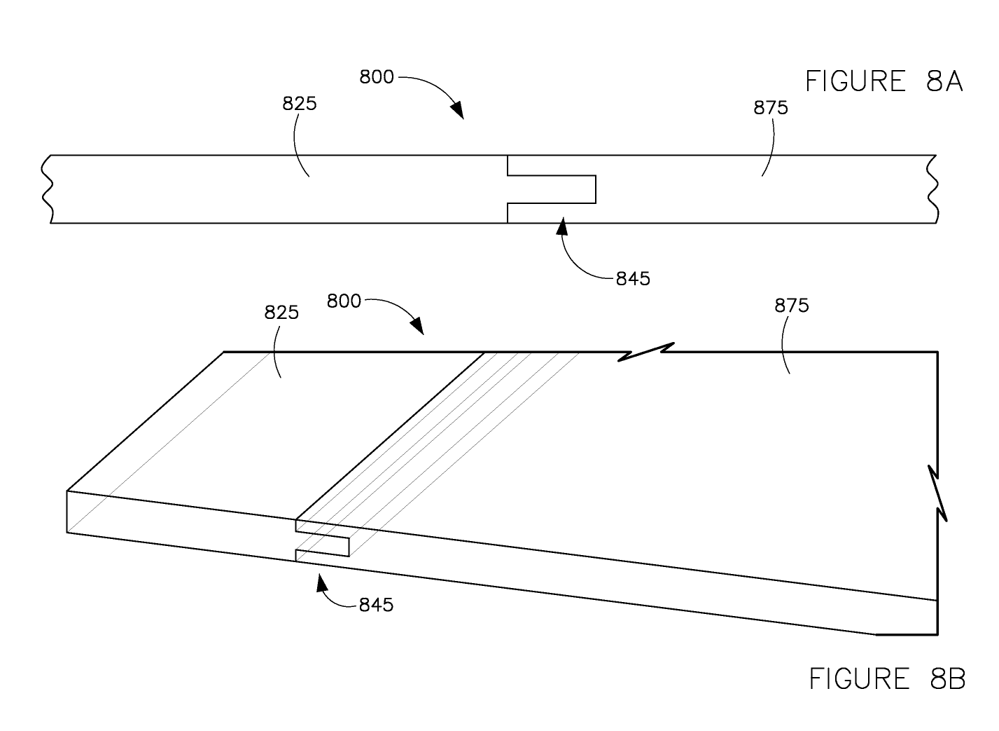

FIGS. 8A and 8B (collectively FIG. 8) illustrate another representative lightguide 800 in accordance with some example embodiments. FIG. 8A illustrates a cross sectional view, while FIG. 8B illustrates a perspective view. The lightguide 800 comprises two lightguide sections 825, 875 that are both formed of optical materials. The lightguide section 825 is formed of an optical material that is rated at a higher operating temperature than the optical material of the lightguide section 875. As discussed above, the lightguide section 825 may be formed of a heat-tolerant material such as optical grade silicone, while the lightguide 875 may be formed of acrylic or another appropriate optical material. The two lightguide sections 825, 875 adjoin one another at an interface 845 through which light passes during operation. In the embodiment of FIG. 8, the interface 845 comprises a tongue-in-groove joint 845. In the illustrated example of FIG. 8, the lightguide section 825 comprises the tongue, and the lightguide section 875 comprises the groove. In an example embodiment, the lightguide section 825 can be formed of a silicone material that has a relatively soft durometer to facilitate material deformation during assembly of the interface 845 and long-term surface contact with lightguide section 875 via a wetting effect.

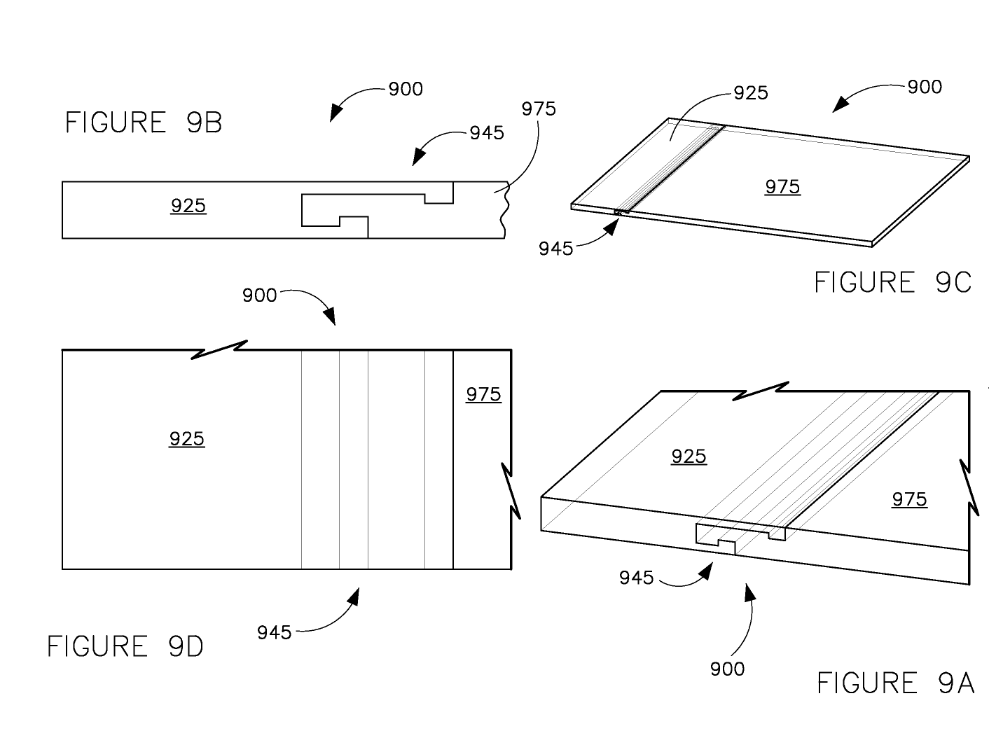

FIGS. 9A, 9B, 9C, and 9D (collectively FIG. 9) illustrate another representative lightguide 900 in accordance with some example embodiments. FIG. 9A illustrates a detail perspective view, FIG. 9B illustrates a cross sectional view, FIG. 9C illustrates a full perspective view, and FIG. 9D illustrates a top-down view. The lightguide 900 comprises two lightguide sections 925, 975 that are both formed of optical materials. The lightguide section 925 is formed of an optical material that is rated at a higher operating temperature than the optical material of the lightguide section 975. As discussed above, the lightguide section 925 may be formed of a heat-tolerant material such as optical grade silicone, while the lightguide 975 may be formed of acrylic or another appropriate optical material. The two lightguide sections 925, 975 adjoin one another at an interface 945 through which light passes during operation. In the embodiment of FIG. 9, the interface 945 is male on lightguide section 925 with two offset inward facing protrusions. The interface 945 is female on the lightguide section 975 with two offset recesses that receive the two offset protrusions of lightguide section 925, thereby forming an example of an interlocking joint configuration. In an example embodiment, the lightguide section 925 can be formed of a silicone material that has a relatively soft durometer to facilitate material deformation during assembly of the interface 945 and long-term surface contact via a wetting effect.

Many modifications and other embodiments of the disclosures set forth herein will come to mind to one skilled in the art to which these disclosures pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of this application. Although specific terms are employed herein, they are used in a generic and descriptive sense only and not for purposes of limitation.

What is claimed is:

1. A lighting system comprising:
a light source; and
a lightguide comprising:
a first edge disposed adjacent the light source to receive light emitted by the light source;
a second edge disposed opposite the first edge, the second edge configured to emit at least a portion of the received light;
a first major surface and a second major surface that extend between the first edge and the second edge and that are configured for internally reflecting the received light and guiding the received light between the first edge and the second edge;
a first optical material extending between the first major surface and the second major surface and from the first edge towards the second edge; and
a second optical material extending between the first major surface and the second major surface and from the second edge towards the first edge.

2. The lighting system of claim 1, wherein the first optical material comprises a thermoset plastic and the second optical material comprises a thermoplastic.

3. The lighting system of claim 1, wherein the first optical material comprises silicone and the second optical material comprises a thermoplastic.

4. The lighting system of claim 1, wherein the first optical material comprises silicone and the second optical material comprises acrylic.

5. The lighting system of claim 1, wherein the first optical material has a first upper temperature rating,
wherein the second optical material has a second upper temperature rating, and
wherein the first upper temperature rating is higher than the second temperature rating.

6. The lighting system of claim 1, wherein the first optical material and the second optical material form an interface that is disposed between the first edge and the second edge and that extends between the first major surface and the second major surface.

7. The lighting system of claim 1, further comprising:
a third edge extending between the first edge and the second edge and between the first major face and the second major face; and
a fourth edge extending between the first edge and the second edge and between the first major face and the second major face,
wherein an interface between the first optical material and the second optical material extends between the third edge and the fourth edge.

8. The lighting system of claim 1, further comprising:
a third edge extending between the first edge and the second edge and between the first major face and the second face; and
a fourth edge, extending between the first edge and the second edge and between the first major face and the second face,
wherein the first optical material extends between the third edge and the fourth edge.

9. The lighting system of claim 1, wherein the lightguide further comprises a projection that is disposed adjacent the first edge and that comprises a channel, and
wherein the lighting system further comprises a plate of glass that is disposed in the channel and that extends adjacent the lightguide, along the first major face.

10. The lighting system of claim 1, wherein the light source comprises an array of light emitting diodes extending along the first edge.

11. A lighting system comprising:
a light source; and
a lightguide that is formed of a thermoplastic optical material and that comprises:
a light-receiving surface that is oriented towards the light source to receive light emitted by the light source;
a light-emitting surface that is disposed opposite the light-receiving surface and that is configured to emit at least a portion of the received light; and
a first major surface and a second major surface that extend between the light-receiving surface and the light-emitting surface and that are configured for internally reflecting the received light and guiding the received light between the light-receiving surface and the light-emitting surface; and
an optic that is formed of a thermoset optical material and that is disposed between the lightguide and the light source.

12. The lighting system of claim 11, wherein the optic comprises a second lightguide.

13. The lighting system of claim 11, wherein the optic comprises:
a second light-receiving surface that is disposed adjacent the light source to receive light from the light source; and
a second light-emitting surface that adheres to the light-receiving surface of the lightguide.

14. The lighting system of claim 11, wherein the optic comprises:
a second light-receiving surface that is disposed adjacent the light source to receive light from the light source; and
a second light-emitting surface that adjoins the light-receiving surface of the lightguide so that the second light-emitting surface and the light-receiving surface form an interface through which light passes.

15. The lighting system of claim 11, wherein the thermoset optical material comprises silicone.

16. The lighting system of claim 11, wherein the thermoplastic comprises acrylic.

17. The lighting system of claim 11, further comprising a plate of glass that extends adjacent the first major surface,
wherein the optic comprises a channel that supports the plate of glass.

18. The lighting system of claim 11, further comprising:
a first plate of glass that extends adjacent the first major surface; and
a second plate of glass that extends adjacent the second major surface,
wherein the optic comprises:
a first channel in which a first edge of the first plate of glass is disposed, and
a second channel in which a second edge of the second plate of glass is disposed.

19. The lighting system of claim 11, wherein the optic comprises:
a concave surface that is internally reflective;
a convex surface that is disposed opposite the concave surface and that is internally reflective, wherein the concave surface and the convex surface are configured to guide light between the light source and the light-receiving surface of the lightguide; and
a projection that extends from the convex surface and that comprises a channel,
wherein the lighting system further comprises a plate of glass that is disposed in the channel and that extends along the first major surface of the lightguide.

20. A method of making a lightguide comprising:
providing a plate that is formed of acrylic optical material and that comprises an edge; and
forming an optic on the edge of the plate by molding silicone to the edge of the plate, wherein the plate and the formed optic comprise the lightguide.
